(19) United States
(12) Patent Application Publication
(10) Pub. No.: US 2026/0278262 A1
(43) Pub. Date: Sep. 17, 2026

(54) INTERACTION METHOD, INTERACTION APPARATUS, AND COMPUTER-READABLE STORAGE MEDIUM

(71) Applicant: Beijing Zitiao Network Technology Co., Ltd., Beijing (CN)

(72) Inventors: Xiang JIANG, Beijing (CN); Yilin HUANGFU, Beijing (CN); Dandan SHEN, Beijing (CN)

(21) Appl. No.: 19/535,804

(22) Filed: Feb. 10, 2026

(30) Foreign Application Priority Data
Mar. 13, 2025 (CN) 202510297886.9

(51) Int. Cl. G06F 40/186; G06F 3/0484

(52) U.S. Cl. CPC G06F 40/186; G06F 3/0484

(57) ABSTRACT

The present disclosure relates to the technical field of computers, and in particular, to an interaction method, an interaction apparatus, a computer-readable storage medium, and a computer program product. The interaction method includes: determining an interaction intention of a user with an agent; displaying a first interface in response to the interaction intention including a creation intention, where the first interface includes at least one creation instruction template control corresponding to a creation genre; displaying a second interface in response to the interaction intention not including the creation intention, where the second interface is a chat interface between the user and the agent; and generating creation content corresponding to the first creation instruction in response to receiving a first creation instruction input by the user in the first interface or the second interface.

### CROSS-REFERENCE TO RELATED APPLICATIONS

This application is based on Chinese application No. 202510297886.9 filed on March 13, 2025 and claims its priority. The disclosure of the Chinese application is hereby incorporated into this application as a whole.

### TECHNICAL FIELD

The present disclosure relates to the technical field of computers, and in particular, to an interaction method, an interaction apparatus, a computer-readable storage medium, and a computer program product.

### BACKGROUND

With the development of computer technologies, in addition to chatting with agents, an increasing number of users use agents to assist creation, especially in the fields of writing and drawing. Artificial intelligence technologies may effectively improve the creation efficiency of users, but users’ requirements for creation experience are getting higher and higher.

### SUMMARY

In view of this, embodiments of the present disclosure provide an interaction method, an interaction apparatus, a computer-readable storage medium, and a computer program product. After determining an intention of a user to start an agent, different interfaces may be displayed for different user intentions, so that the user may use corresponding functions without selecting an interface on his or her own, thereby improving user experience.

According to some embodiments of the present disclosure, there is provided an interaction method, including: determining an interaction intention of a user with an agent; displaying a first interface in response to the interaction intention comprising a creation intention, wherein the first interface comprises at least one creation instruction template control corresponding to a creation genre; displaying a second interface in response to the interaction intention not comprising the creation intention, wherein the second interface is a chat interface between the user and the agent; and generating creation content corresponding to the first creation instruction in response to receiving a first creation instruction input by the user in the first interface or the second interface.

According to some other embodiments of the present disclosure, there is provided an interaction apparatus, including: a determination module configured to determine an interaction intention of a user with an agent; a first display module configured to display a first interface, wherein the first interface comprises at least one creation instruction template control corresponding to a creation genre in response to the interaction intention comprising a creation intention; a second display module configured to display a second interface, wherein the second interface is a chat interface between the user and the agent in response to the interaction intention not comprising the creation intention; and a generation module configured to generate creation content corresponding to the first creation instruction in response to receiving a first creation instruction input by the user in the first interface or the second interface.

According to some embodiments of the present disclosure, there is provided an interaction apparatus, including: a memory; and a processor coupled to the memory, where the processor is configured to, based on instructions stored in the memory, execute the method of any one of the embodiments of the present disclosure.

According to some embodiments of the present disclosure, there is provided a computer-readable storage medium having a computer program stored thereon, where the program, when executed by a processor, executes the method of any one of the embodiments of the present disclosure.

Other features, aspects, and advantages of the present disclosure become apparent through the following detailed description of exemplary embodiments of the present disclosure with reference to the drawings.

### BRIEF DESCRIPTION OF THE DRAWINGS

Embodiments of the present disclosure are described hereinafter with reference to the drawings. It is to be understood that the drawings in the following description relate to only some embodiments of the present disclosure and are not to be construed as limiting the present disclosure. In the drawings:

FIG. 1 is a schematic flowchart of an interaction method according to some embodiments of the present disclosure;

FIG. 2A is a schematic diagram showing a first interface according to some embodiments of the present disclosure;

FIG. 2B is a schematic diagram showing a second interface according to some embodiments of the present disclosure;

FIG. 2C is a schematic diagram showing a second interface according to some other embodiments of the present disclosure;

FIG. 3 is a schematic flowchart of an interaction method according to some other embodiments of the present disclosure;

FIGS. 4A to 4C are schematic diagrams of displaying a new document control according to some embodiments of the present disclosure;

FIG. 4D is a schematic diagram showing a third interface according to some embodiments of the present disclosure;

FIG. 4E is a schematic diagram showing content and a creation instruction input in the third interface according to some embodiments of the present disclosure;

FIG. 5A is a schematic diagram showing creation content displayed according to some embodiments of the present disclosure;

FIG. 5B is a schematic diagram showing a creation content encapsulation entity displayed according to some embodiments of the present disclosure;

FIG. 6 is a schematic diagram of inputting an editing instruction according to some embodiments of the present disclosure;

FIG. 7 is a schematic diagram of inputting an editing instruction according to some other embodiments of the present disclosure;

FIG. 8 is a schematic diagram of inputting an editing instruction according to some further embodiments of the present disclosure;

FIG. 9 is a schematic diagram showing prompt information displayed according to some embodiments of the present disclosure;

FIG. 10 is a schematic diagram showing a history interaction record displayed according to some embodiments of the present disclosure;

FIG. 11 is a block diagram of an interaction apparatus according to some embodiments of the present disclosure;

FIG. 12 is a block diagram of an interaction apparatus according to some other embodiments of the present disclosure; and

FIG. 13 is a block diagram of an interaction apparatus according to some further embodiments of the present disclosure.

It is to be understood that, for ease of description, the dimensions of various parts shown in the drawings are not necessarily drawn to scale. Throughout the drawings, the same or similar reference numerals denote the same or similar components. Therefore, once an item is defined in one drawing, it may not be discussed further in subsequent drawings.

### DETAILED DESCRIPTION OF EMBODIMENTS

The technical solutions in the embodiments of the present disclosure are clearly and completely described hereinafter with reference to the drawings in the embodiments of the present disclosure. It is to be understood that the present disclosure may be implemented in various forms and should not be construed as limited to the embodiments set forth herein.

It is to be understood that steps described in method implementations of the present disclosure may be performed in a different order and/or in parallel. In addition, the method implementations may include additional steps and/or omit performing illustrated steps. The scope of the present disclosure is not limited in this respect. Unless otherwise specifically stated, relative arrangements of components and steps and numerical values set forth in these embodiments are to be construed as merely exemplary and do not limit the scope of the present disclosure.

The term "include/comprise" and variations thereof used in the present disclosure are open-ended terms that mean "include/comprise at least the following elements/features, but do not exclude other elements/features", that is, "include/comprise but not limited to". The term "based on" means "based at least partially on".

It is to be noted that concepts such as "first" and "second" mentioned in the present disclosure are merely used to distinguish between different apparatuses, modules, or units and are not used to limit an order or interdependence of functions performed by these apparatuses, modules, or units. Unless otherwise specified, concepts such as "first" and "second" are not intended to imply that objects so described must be in a given order temporally, spatially, in ranking, or in any other manner.

It is to be noted that modifications of "one" and "multiple" mentioned in the present disclosure are illustrative and not restrictive, and those skilled in the art should understand that "one" or "multiple" should be understood as "one or more" unless clearly expressed in the context.

Names of messages or information exchanged between multiple apparatuses in the implementations of the present disclosure are used for illustrative purposes only and are not used to limit the scope of these messages or information.

User information (including but not limited to user device information, user personal information, and the like) and data (including but not limited to data for analysis, stored data, displayed data, and the like) involved in the present disclosure are information and data authorized by a user or fully authorized by parties, and collection, use, and processing of the related data need to comply with related laws, regulations, and standards of related countries and regions, and corresponding operation entry is provided for the user to select authorization or rejection.

Embodiments of the present disclosure are described in detail hereinafter with reference to the drawings, but the present disclosure is not limited to these specific embodiments. The following specific embodiments may be combined with each other, and the same or similar concepts or processes may not be described in detail in some embodiments. In addition, in one or more embodiments, specific features, structures, or characteristics may be combined in any suitable manner as will be clear to those of ordinary skill in the art from the present disclosure.

In an interaction process in the related art, a user's interaction intention is usually not determined, and an interface corresponding to a function that the user desires to use cannot be directly provided for the user, resulting in a poor user experience. To improve the user experience, an embodiment of the present disclosure provides a new interaction method. After determining a user's intention, different interfaces may be displayed for different user intentions, so that the user may use corresponding functions, thereby improving the user experience.

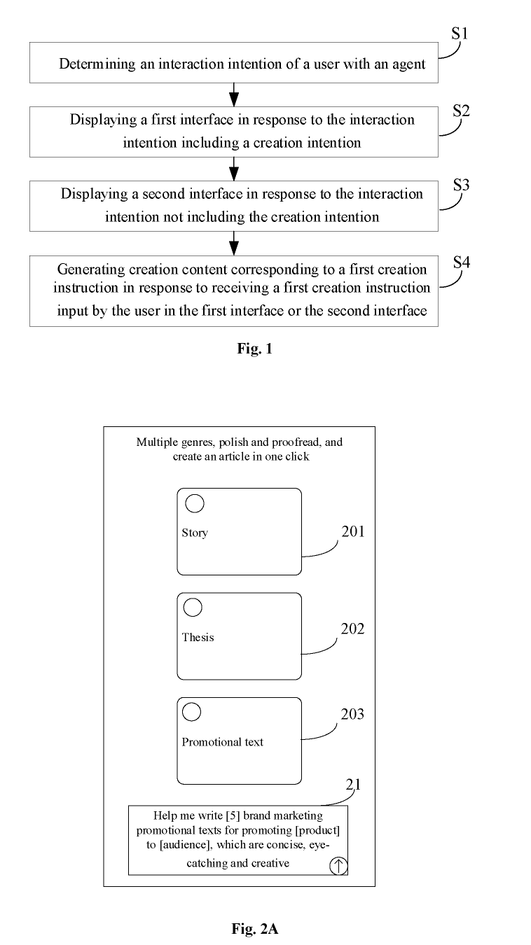

FIG. 1 is a schematic flowchart of an interaction method according to some embodiments of the present disclosure.

As shown in FIG. 1, the interaction method includes: step S1, determining an interaction intention of a user with an agent; step S2, displaying a first interface in response to the interaction intention including a creation intention, where the first interface includes at least one creation instruction template control corresponding to a creation genre; step S3, displaying a second interface in response to the interaction intention not including the creation intention, where the second interface is a chat interface between the user and the agent; and step S4, generating creation content corresponding to the first creation instruction in response to receiving a first creation instruction input by the user in the first interface or the second interface.

The agent may be an agent based on a large language model (LLM) or other natural language processing (NLP) models. For example, the agent may be constructed using a machine learning model, such as a variational autoencoder (VAE), a convolutional neural network (CNN), or a transformer.

The user's interaction intention with the agent is, for example, a function that the user desires to implement through the agent. For example, in the case where the user desires to chat with the agent, it may be determined that the user's interaction intention is a chat intention.

The creation intention in the interaction intention includes, for example, a writing intention, a drawing intention, a composition intention, and the like, which represent an intention of the user to have a creation requirement. For example, in the case where the user desires to write through the agent, it may be determined that the user's interaction intention is the writing intention.

The user's interaction intention with the agent may be determined based on information, such as a habit of the user using the agent or other actions performed by the user before using the agent. The above information may be collected after the user authorizes. For example, if the user starts the agent 8 times out of 10 times before this time of starting the agent for writing, it may be determined that the user's interaction intention with the agent this time is also the writing intention.

After determining the user's interaction intention with the agent, it may be determined whether the interaction intention includes the creation intention. In the case where the user's interaction intention includes the creation intention, the first interface may be displayed for the user. The first interface is, for example, a creation interface and may include at least one creation instruction template control corresponding to different creation genres. In response to the user's trigger operation on the creation instruction template control, a creation instruction template may be displayed for the user. The user may modify a parameter in the creation instruction template to complete a creation instruction and instruct the agent to perform corresponding creation.

For example, the first interface displayed for the user with the writing intention may include controls corresponding to different writing styles, such as a composition, a thesis, and a promotional text. After the user clicks on the control corresponding to the thesis, a creation instruction template "My research field is [please input a research field], help me write a thesis about [please input a theme]" may be displayed. The user may input the research field and the theme to complete the creation instruction, thereby improving the creation efficiency.

In the case where the user's interaction intention does not include the creation intention, the second interface may be displayed for the user. The second interface may be a chat interface between the user and the agent. The chat interface may be an interface where the user chats with the agent separately, and a history interaction record between the user and the agent is displayed in the interface; or the chat interface may be a chat list interface of agents that have chatted with the user, and a list of agents that have chatted with the user is displayed in the interface.

In the case where the user needs to create, the user may input a creation instruction in the first interface or the second interface. After receiving the creation instruction, the agent generates creation content corresponding to the creation instruction.

The basic interaction method according to the embodiment of the present disclosure is described above with reference to FIG. 1. According to the interaction method provided in the present disclosure, after determining the user's intention, different interfaces may be displayed for different user intentions, so that the user may use corresponding functions, thereby improving the user experience.

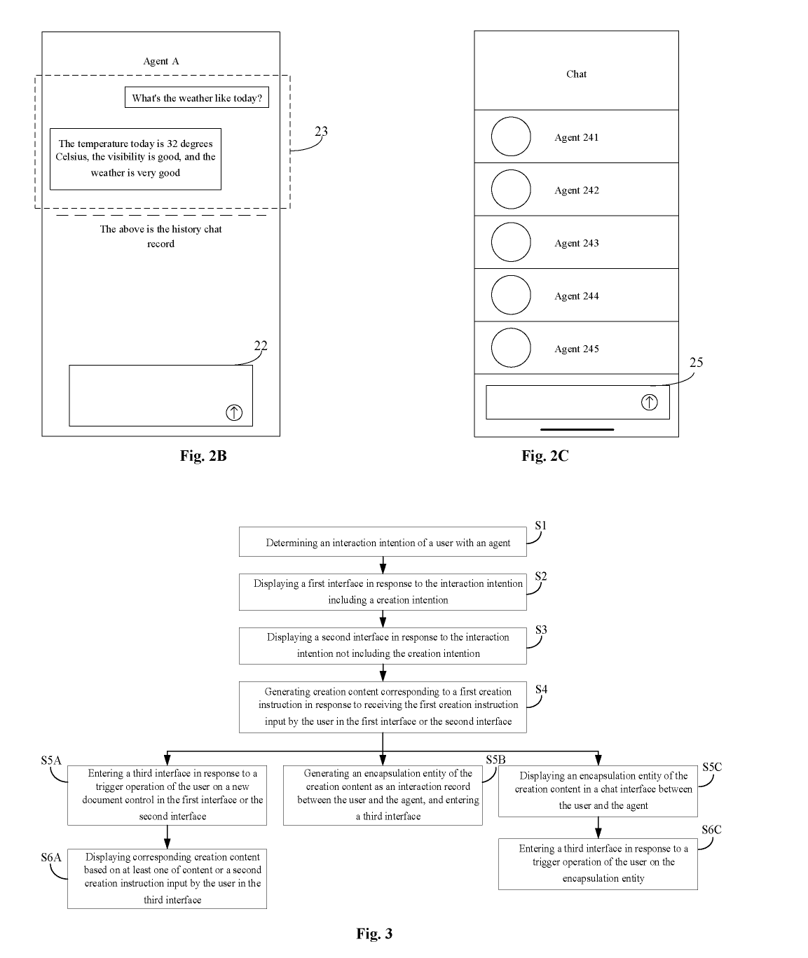

Hereinafter, schematic diagrams of interfaces according to embodiments of the present disclosure are described with reference to FIGS. 2A to 2C.

FIG. 2A is a schematic diagram showing a first interface according to some embodiments of the present disclosure.

As shown in FIG. 2A, in the case where it is determined that the user's interaction intention includes the creation intention, the first interface may be displayed. The first interface may include creation instruction template controls 201 to 203 and an input box 21, where the creation instruction template controls may correspond to different creation genres. For example, as shown in FIG. 2A, the control 201 may be a control corresponding to a story, the control 202 may be a control corresponding to a thesis, and the control 203 may be a control corresponding to a promotional text.

In some embodiments, determining the user's interaction intention with the agent includes: determining the interaction intention based on a history interaction record between the user and the agent.

For example, in the case where it is mentioned in the history interaction record between the user and the agent that the user may need to write a thesis or draw in the near future, it may be determined that the user's interaction intention includes the creation intention.

In response to the user's trigger control on the creation instruction template control, a creation instruction template corresponding to the control may be displayed in the input box 21 of the first interface. In the example shown in FIG. 2A, in response to the user triggering the control 201, the input box 21 displays the creation instruction template "Help me write [5] brand marketing promotional texts for promoting [product] to [ audience], which are concise, eye-catching, and creative", where a target audience and a promotional product may be input by the user, and a number of promotional texts may be directly input by the user or input by the user, for example, through selection in a drop-down tab.

In the case where it is determined that the user desires to create, the above creation instruction template control is displayed for the user when the user starts. Through the above creation instruction template control, the user may determine a creation instruction template corresponding to a desired genre and fill in or select a parameter in the creation instruction template to complete the creation instruction for creation, thereby improving the user experience.

FIG. 2B is a schematic diagram showing a second interface according to some embodiments of the present disclosure.

As shown in FIG. 2B, the second interface, that is, the chat interface between the user and the agent, may be a separate chat interface between the user and a specific agent, and the second interface includes an input box 22 for the user to chat with the agent and a history chat record 23 between the user and the agent. The agent A shown in FIG. 2B may be, for example, an agent that chats with the user the most or an agent with the widest range of application fields.

FIG. 2C is a schematic diagram showing a second interface according to some other embodiments of the present disclosure.

As shown in FIG. 2C, the chat interface between the user and the agent may also be a chat list interface of agents that have chatted with the user, and the chat interface includes agents 241 to 245 and an input box 25. The agent corresponding to the input box 25 may be, for example, set as the first agent in the chat list. The user may input a creation instruction through the input box 25 to instruct the agent 241 to create. In addition, in response to the user's trigger operation on different agents displayed in the chat interface, a separate chat interface with a corresponding agent may be entered.

By displaying the chat interface with the agent for the user when the user starts, diverse requirements of the user may be satisfied as much as possible without determining the user's intention.

Examples of the interface proposed in the present disclosure are described above with reference to FIGS. 2A to 2C. Hereinafter, a content display interface in the present disclosure is described with reference to FIGS. 3 to 5. By displaying the creation content in the content display interface, it is beneficial for the user to perform subsequent editing. FIG. 3 is a schematic flowchart of an interaction method according to some other embodiments of the present disclosure.

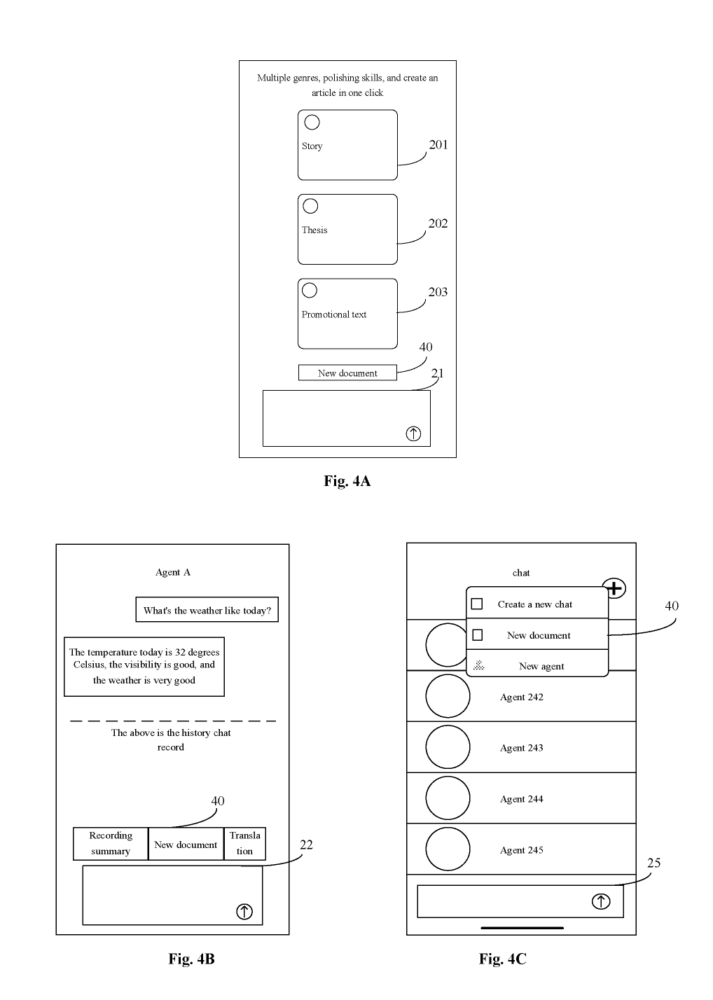

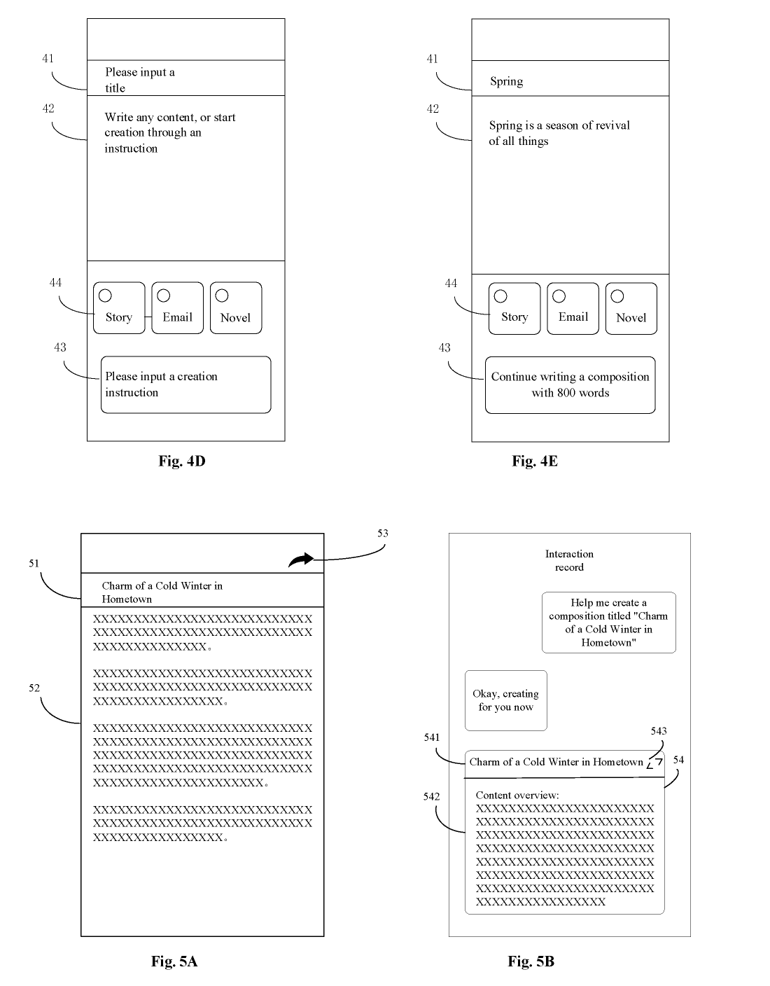

FIG. 3 shows three manners of entering the content display interface (that is, the third interface). First, a first manner of entering the third interface, that is, entering the third interface through a new document control, is described with reference to FIGS. 4A to 4E. As shown in FIG. 3, based on steps S1 to S4 in FIG. 1, the interaction method according to some embodiments of the present disclosure may further include: step S5A, in response to the user's trigger operation on a new document control in the first interface or the second interface, entering a third interface, where the third interface displays creation content in a full screen manner to edit the creation content; and step S6A, displaying corresponding creation content based on at least one of content or a second creation instruction input by the user in the third interface.

Steps S1 to S4 have been described above and are not described herein again. Steps S5A and S6A are mainly described below. Based on steps S5A and S6A, in the case where the user desires to create, the user may also first enter the third interface, that is, the content display interface, and then create by inputting at least one of content or a creation instruction.

FIGS. 4A to 4C are schematic diagrams of displaying a new document control according to some embodiments of the present disclosure. FIG. 4D is a schematic diagram showing a third interface according to some embodiments of the present disclosure.

FIG. 4A shows the new document control 40 displayed in the first interface, FIG. 4B shows the new document control 40 displayed in the case where the second interface is the separate chat interface, and FIG. 4C shows the new document control 40 displayed in the case where the second interface is the chat list interface.

It may be seen that in different interfaces, the new document control 40 may be displayed in different manners, for example, directly displayed in the interface or displayed in a collapsed tab list in the interface. It should be noted that the above display manners are only exemplary and non-restrictive. The new document control may be displayed in different interfaces in the same manner, or may be displayed in a display manner different from that shown in the above figures.

In step S5A, the user may use the new document control 40 shown in FIGS. 4A to 4C to enter the third interface shown in FIG. 4D, that is, the content display interface, where the content display interface shown in FIG. 4D displays a newly created blank document. As shown in FIG. 4D, the third interface may be a content display interface displayed in a full screen manner, and the third interface may include a title portion 41, a content portion 42, an input box 43, and a creation instruction template control 44.

For the newly created blank document, the title portion 41 may display a prompt of "Please input a title", the content portion 42 may display a prompt of "Write any content, or start creation through an instruction", and the input box may display a prompt of "Please input a creation instruction".

In addition, the content display interface may further include the creation instruction template control 44 similar to the creation instruction template control in FIG. 2A. In response to the user's trigger operation on the creation instruction template control 44, a creation instruction template corresponding to a genre may be displayed in the input box 43.

In step S6A, the user may input at least one of content or a second creation instruction in the content display interface to create.

FIG. 4E is a schematic diagram showing content and a creation instruction input in the third interface according to some embodiments of the present disclosure. As shown in FIG. 4E, for example, in the case where the user desires to write a composition, the user may input a title "Spring" in the title portion 41 of the blank document shown in FIG. 4D, input the beginning of the composition "Spring is a season of revival of all things" in the content portion 42, and then input a corresponding creation instruction, such as "Continue writing a composition with 800 words", in the input box 43.

Through the above input, the agent may be instructed to create in combination with the content and the creation instruction input by the user, thereby improving the flexibility of the user using the agent to create and improving the user's creation experience.

In some embodiments, the user may also input relatively complete creation content without inputting a creation instruction, and the user may directly perform subsequent editing. For example, in the case where the user has completed a composition and desires the agent to modify the composition, the user may input his or her own composition in the title portion 41 and the content portion 42 of the content display interface.

Through the above interaction method, the user may be provided with a new manner of starting creation, and creation may be performed based on the content input by the user in the content display interface, thereby improving the user's creation efficiency and improving the user experience. In addition, the content display interface in the present disclosure displays the creation content in a full screen manner, which allows the user to perform immersive creation and may also improve the user experience.

It is described above that the content display interface is entered through the new document control, and after entering the content display interface, creation is performed by inputting at least one of content or a creation instruction. Hereinafter, how to enter the third interface after the creation instruction is input in the first interface or the second interface is described with reference to FIGS. 5A and 5B, that is, two other manners of entering the third interface are described.

As shown in FIG. 3, based on FIG. 1, the interaction method according to some other embodiments of the present disclosure may further include: step S5B, generating an encapsulation entity of the creation content as an interaction record between the user and the agent, and entering a third interface, where the third interface displays the creation content in a full screen manner to edit the creation content.

FIG. 5A is a schematic diagram showing creation content displayed according to some embodiments of the present disclosure. FIG. 5B is a schematic diagram showing a creation content encapsulation entity displayed according to some embodiments of the present disclosure.

Based on step S5B, after the user inputs the creation instruction in the first interface or the second interface, the third interface shown in FIG. 5A may be automatically entered, and the encapsulation entity of the generated creation content is saved in the interaction record between the user and the agent, as shown in FIG. 5B, for subsequent viewing.

It is to be understood that the display manners shown in FIGS. 5A and 5B are only exemplary and non-restrictive. The content display interface may also use other layouts or display manners to display the creation content, and the encapsulation entity of the creation content may also be displayed in other manners, such as a preview window.

As shown in FIG. 5A, the content display interface may include, for example, a title portion 51, a content portion 52, and a sharing control 53. After the user inputs the creation instruction, the content display interface may be directly entered, and the creation content generated by the agent for the user's creation instruction is displayed in the title portion 51 and the content portion 52. In some embodiments, the creation content is shared in response to the user's trigger operation on the sharing control 53 in the third interface.

In the case where the user desires to share the creation content of the user or the agent, the user may directly share the creation content through the sharing control in the content display interface without sharing a chat record between the user and the agent in the chat interface. Through the above manner, it may be avoided that the shared content further includes other content such as the chat record, thereby improving the sharing experience.

It is to be understood that the above sharing control may be used not only for the third interface shown in FIG. 5A, but also for any other third interface according to the embodiments of the present disclosure, so that the user may share the creation content.

FIG. 5A shows the case where the creation content is displayed in the content display interface after the user inputs the writing creation instruction. In addition to the writing creation instruction, the user may further input other types of creation instructions, such as a painting creation instruction and a composition creation instruction. The agent may use the third interface with different representations to display the creation content generated for other types of creation instructions of the user.

In addition, in step S5B, after the creation content is generated based on the first creation instruction input by the user, the encapsulation entity of the creation content may be generated. The encapsulation entity of the creation content may be, for example, a card or a preview image. Through the encapsulation entity of the creation content, the creation content may be displayed in a small area for the user to quickly browse.

After generating the encapsulation entity, the agent may save the encapsulation entity to the interaction record and provide the encapsulation entity to the user when the user views the interaction record subsequently or returns to the chat interface with the agent subsequently.

For example, after browsing or editing the content in the content display interface, the user may return from the content display interface to the separate chat interface between the user and the agent. In the separate chat interface, the interaction record between the user and the agent shown in FIG. 5B may be displayed, and the interaction record may include the above encapsulation entity, thereby allowing the user to browse the creation content in combination with historical interactions such as the creation instruction, thereby improving the user experience.

In some embodiments, after entering the content display interface, the creation process of the creation content may be displayed in the content display interface. For example, when writing, the creation content may be displayed to the user word by word by imitating a typing process. For another example, when painting, the creation process of the painting may be dynamically displayed. Through the above display, the user's creation participation may be further improved, thereby improving the user experience.

The manner of entering the third interface after the creation instruction is input is described above. The third interface shown in FIG. 5A may be directly entered and the creation content is displayed in the third interface. If necessary, the user may return to the separate chat interface to display the interaction record shown in FIG. 5B. Hereinafter, another manner of entering the third interface after the creation instruction is input is described.

As shown in FIG. 3, based on FIG. 1, the interaction method according to still some embodiments of the present disclosure may further include: step S5C, displaying an encapsulation entity of the creation content in the chat interface between the user and the agent; and step S6C, in response to the user's trigger operation on the encapsulation entity, entering a third interface, where the third interface displays the creation content in a full screen manner to edit the creation content.

For example, after the creation content is completed, the interaction record shown in FIG. 5B, which includes the encapsulation entity of the creation content, may be first displayed in the separate chat interface between the user and the agent. The third interface shown in FIG. 5A is entered to display the creation content in a full screen manner only in response to the user's trigger operation.

In step S5C, the interaction record shown in FIG. 5B may be displayed in the separate chat interface for the user to quickly preview.

As shown in FIG. 5B, the encapsulation entity may be generated in the form of a card 54. In the separate chat interface, the creation content may be displayed in an area of the card 54. The card 54 includes, for example, a title 541, content 542, and an expand control 543. At the content 542, an overview of the creation content may be displayed.

In some embodiments, the creation content itself may also be displayed at the content 542, and in response to the user's swipe operation on the card, the content displayed on the card may be changed, thereby allowing the user to browse.

The user may perform a preliminary judgment on whether the creation content generated by the agent meets a requirement based on the creation content displayed by the encapsulation entity, and in the case where the creation content does not meet the requirement, the user may directly instruct the agent to re-generate the creation content.

In step S6C, in the case where the user desires to further browse the complete creation content, the user may enter the third interface through the trigger operation on the encapsulation entity.

For example, the user may double-click on the encapsulation entity or the expand control in the encapsulation entity to enter the content display interface shown in FIG. 5A from the separate chat interface to further browse and edit the creation content.

It is to be understood that the above separate chat interface is only exemplary, and the interaction record including the encapsulation entity of the creation content shown in FIG. 5B may also be displayed in other interfaces.

Different manners of entering the content display interface in the present disclosure are described above with reference to FIGS. 3 to 5. The full screen content display interface provides the user with an immersive creation environment, and the user is provided with a variety of manners of entering the content display interface, thereby improving the user's creation experience and improving the user experience. Hereinafter, how to edit the creation content is further described with reference to FIGS. 6 to 8.

In some embodiments, the interaction method may further include: in the third interface, displaying an input box for chatting with the agent in the form of a floating layer; and editing the creation content based on a first editing instruction input by the user in the input box.

FIG. 6 is a schematic diagram showing an editing instruction input according to some embodiments of the present disclosure. As shown in FIG. 6, the third interface may include an input box 61 displayed in the form of a floating layer.

The user may input the editing instruction through the above input box, for example, in text or voice, to edit the creation content.

In the example of FIG. 6, in the case where the user desires to modify the entire creation content, for example, add some rhetorical devices, the user may input "Polish the entire text in a style with more rhetorical devices" in the input box 61 as the editing instruction, to implement editing of the creation content.

In addition, the creation content may be not only writing content, but also creation content in other forms such as painting content. In the case where the creation content is a painting, the painting may be displayed in an immersive manner in the content display interface, and the input box may also be displayed in the form of a floating layer at the bottom of the interface, so as to receive the user's editing instruction.

In some embodiments, the agent may understand the editing instruction input by the user through the input box, to determine the content in the creation content that the user desires to edit, and edit the content based on the editing instruction. Manners of understanding the editing instruction may include semantic understanding, visual understanding, and syntax tree positioning.

In the case where the content that the user desires to edit is only a part of the creation content, by first understanding the editing instruction, the editing workload may be reduced, and the user's creation efficiency may be improved, thereby improving the user's creation experience.

For example, in the case where the editing instruction input by the user is "Expand the last paragraph", semantic understanding may be first performed on the user's editing instruction to determine that the content that the user desires to edit is the last paragraph of the creation content, and the last paragraph is expanded based on the editing instruction.

According to the above interaction method, by displaying the input box in the form of a floating layer in the full screen third interface to receive the user's editing instruction, the user's immersive experience in the creation process may be improved, and the user may be prevented from being disturbed by repeated generation of content.

The above interaction method provides one manner of editing the entire creation content, and another manner of editing the entire creation content is described below.

In some embodiments, the interaction method may further include: in the third interface, in response to the user's trigger operation on the creation content, recommending at least one candidate editing instruction related to the creation content to the user; and editing the creation content based on a second editing instruction selected by the user from the candidate editing instruction(s).

The user's trigger operation on the creation content may include, for example, staying for a specified time, triggering a control displayed in association with the creation content, etc. Based on the above trigger operation, it may be determined that the user may desire to modify the creation content, and the candidate editing instruction may be recommended for the user.

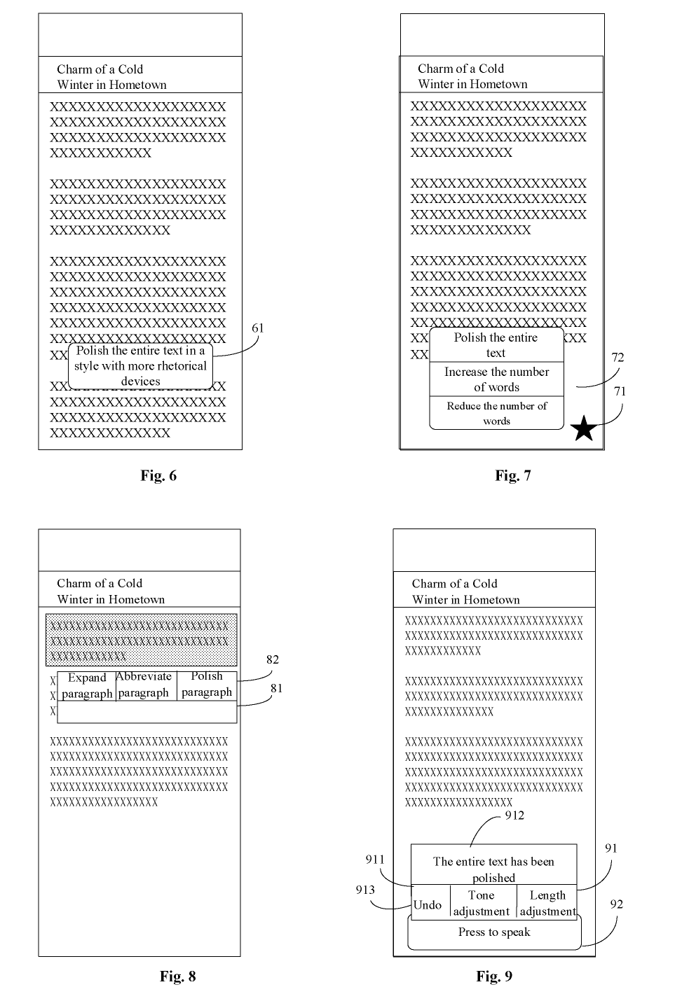

FIG. 7 is a schematic diagram showing an editing instruction input according to some other embodiments of the present disclosure. As shown in FIG. 7, the third interface may include a control 71 displayed in association with the creation content, and in response to the user's trigger operation on the control 71, the recommended candidate editing instruction 72 may be displayed in the third interface.

As shown in FIG. 7, in the case where the user is writing, the candidate editing instruction may be, for example, a common writing editing instruction such as "Polish the entire text", "Increase the number of words", or "Reduce the number of words". The user may modify the creation content by selecting the second editing instruction from the candidate editing instruction. Through the above manner, the user may be allowed to quickly input the editing instruction by selection, thereby improving the user experience.

In some embodiments, the candidate editing instruction may also be determined based on understanding of the creation content. For example, the candidate editing instruction for the novel content may include "Modify characters", and the candidate editing instruction for the thesis may include "Add references". By understanding the creation content, a more suitable candidate editing instruction may be provided for the user, thereby improving the user experience.

In the interaction method proposed in the present disclosure, in addition to modifying the entire creation content as described above, a part of the creation content may also be edited. How to specifically edit the part of the creation content is described below.

In some embodiments, the interaction method further includes: in the third interface, in response to the user's trigger operation on target content in the creation content, recommending at least one candidate editing instruction related to the target content to the user, and editing the target content based on a third editing instruction selected by the user from the candidate editing instruction(s).

In some other embodiments, the interaction method further includes: in the third interface, in response to the user's trigger operation on target content in the creation content, editing the target content based on a fourth editing instruction input by the user in an input box in the third interface.

The user's trigger operation on the target content may be, for example, selecting the target content, triggering a control displayed in association with the target content, etc. Through the above trigger operation, the target content that the user desires to edit may be determined, and the target content may be a part of the creation content.

The above embodiments provide two manners in which the user edits the part of the creation content. The candidate editing instruction related to the target content may be recommended to the user for selection, or the editing instruction input by the user through the input box may be received.

FIG. 8 is a schematic diagram showing an editing instruction input according to still some embodiments of the present disclosure. As shown in FIG. 8, in the case where the user selects a specific paragraph in the creation content, for example, the input box 81 and the candidate editing instruction 82 may be displayed in the third interface.

As shown in FIG. 8, after the user selects the target content, the input box 81 may be displayed in the form of a floating layer under the paragraph selected by the user. The user may input the editing instruction in the input box to edit the target content selected by the user.

In addition, after the user selects the target content, the candidate editing instruction 82 related to the target content, such as common paragraph editing instructions like "Expand the paragraph", "Abbreviate the paragraph", and "Polish the paragraph", may be displayed in the form of a floating layer under the paragraph selected by the user.

In some embodiments, the candidate editing instruction may also be determined based on semantic understanding of the target content and a relative position relationship of the target content in the creation content. Through the above determination manner, the candidate editing instruction more in line with the target content may be provided for the user, thereby improving the user's editing experience.

It is to be understood that the above display manner is only exemplary, and in the interaction method proposed in the present disclosure, only the input box 81 or only the candidate editing instruction 82 may be displayed.

According to the above interaction method, on the basis of the overall modification, the user may be allowed to select a part of the creation content displayed in the content display interface for modification. During paragraph modification, only the paragraph that needs to be modified may be re-generated without re-generating the entire creation content, thereby further improving the user's editing experience.

How to edit the creation content in the content display interface is described above. Hereinafter, how the agent prompts the user that the editing is completed after the editing is described.

In some embodiments, the interaction method may further include: in response to completion of editing the creation content, displaying corresponding prompt information in the third interface in the form of a floating layer, where the prompt information includes at least one of progress prompt indicating completion of the editing or recommended editing instruction for subsequent editing.

FIG. 9 is a schematic diagram showing prompt information display according to some embodiments of the present disclosure. As shown in FIG. 9, after the editing is completed, prompt information 91 and an input box 92 may be displayed in the content display interface in the form of a floating layer, where the prompt information 91 may include a progress prompt 911, a candidate editing instruction 912, and an undo control 913.

During writing creation, in the case where the editing instruction input by the user includes "Polish the entire text", the progress prompt 911 associated with the editing performed by the agent may be "The entire text has been polished", and the recommended candidate editing instruction 912 may be "Tone adjustment", "Length adjustment", etc.

Through the above prompt information, the user may be allowed to obtain the information related to the editing instruction input by the user in the full screen third interface without displaying the complete interaction record between the user and the agent, thereby improving the user's immersive experience.

In addition, after the editing is completed, the user may determine whether to perform the editing based on the edited creation content. For example, in the case where the user considers the editing unreasonable, the user may undo the editing through the undo control 913 in FIG. 9 and return to displaying the creation content before the editing.

Similarly, after completing the generation of the edited creation content, the agent may also display the edited creation content in the third interface, for example, in the form of a floating layer, for the user to confirm. In response to receiving the user's confirmation trigger operation, the content before the editing may be replaced with the edited content. The confirmation trigger operation may include, for example, clicking a confirmation control, staying for a specified time, etc.

FIG. 9 also shows the input box 92 for voice input. In response to the user's trigger operation on the input box 92, acceptance of the user's voice information may be started, and the voice information may be converted into text as the editing instruction input by the user.

In some embodiments, displaying the corresponding prompt information may include: displaying the corresponding prompt information within a specified time after completing the editing of the creation content.

In other words, the prompt information may be displayed, for example, only within 5 seconds after the editing is completed, so as to avoid disturbing the user when browsing the edited creation content, thereby improving the user's immersive experience.

It is to be understood that the above display manner is only exemplary, and in the interaction method proposed in the present disclosure, only the progress prompt 911 or only the candidate editing instruction 912 may be displayed.

In some embodiments, the interaction method may further include: in response to the user's trigger operation on the prompt information, displaying a history interaction record related to the first creation instruction in the third interface in the form of a floating layer, where the history interaction record includes an encapsulation entity of the edited creation content.

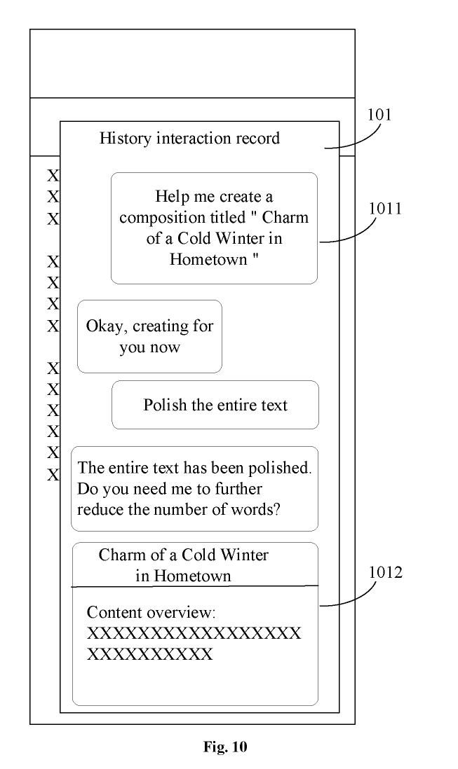

FIG. 10 is a schematic diagram showing a history interaction record displayed according to some embodiments of the present disclosure. As shown in FIG. 10, after the user triggers the prompt information, such as the prompt information 91 in FIG. 9, the history interaction record 101 related to the first creation instruction may be displayed. The history interaction record 101 may include the first creation instruction 1011 and the encapsulation entity of the edited creation content 1012 for the user to browse.

The user's trigger operation on the prompt information 91 may include, for example, clicking the prompt information 91 or dragging the prompt information 91. In response to the user's trigger operation, for example, the prompt information 91 may be expanded, so that the history interaction record between the user and the agent related to the first creation instruction is also displayed in the form of a floating layer in the content display interface.

Through the above manner, the information related to the creation and editing may be provided for the user when the user needs, thereby improving the user's creation experience.

The above is the interaction method provided in the embodiment of the present disclosure. According to the above interaction method of the present disclosure, after determining the user's intention, different interfaces may be displayed for different user intentions, so that the user may use corresponding functions, thereby improving the user experience.

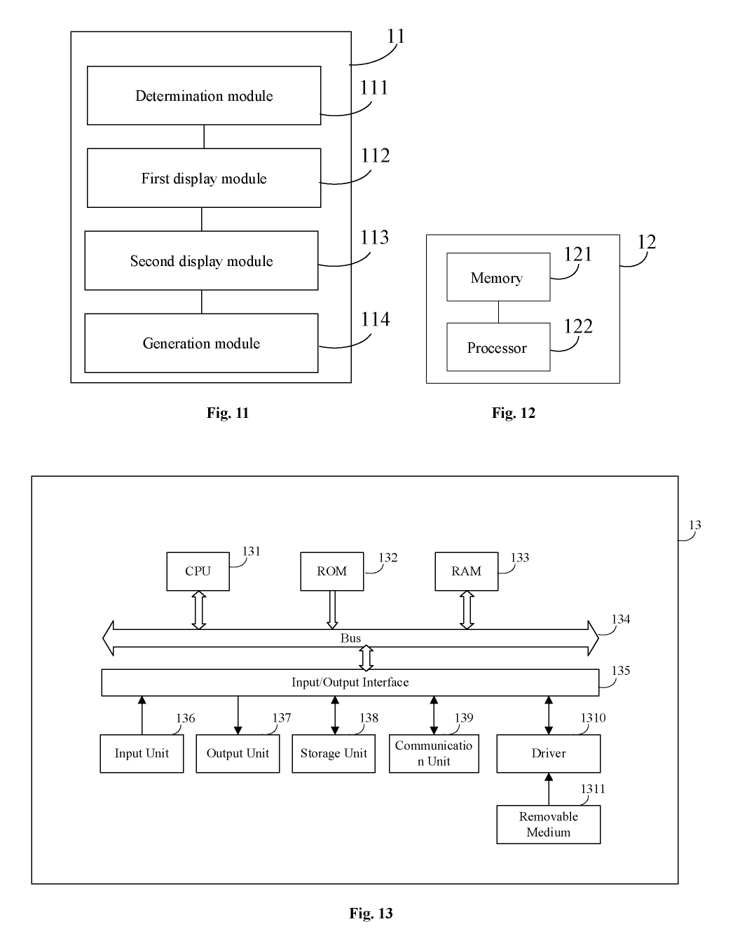

An interaction apparatus according to an embodiment of the present disclosure is described below with reference to FIGS. 11 and 12, and the interaction apparatus is configured to perform any one of the above interaction methods. FIG. 11 is a block diagram of an interaction apparatus according to some embodiments of the present disclosure.

As shown in FIG. 11, the interaction apparatus 11 includes: a determination module 111 configured to determine an interaction intention of a user with an agent; a first display module 112 configured to, in response to the interaction intention including a creation intention, display a first interface, where the first interface includes at least one creation instruction template control corresponding to a creation genre; a second display module 113 configured to, in response to the interaction intention not including the creation intention, display a second interface, where the second interface is a chat interface between the user and the agent; and a generation module 114 configured to, in response to receiving a first creation instruction input by the user in the first interface or the second interface, generate creation content corresponding to the first creation instruction.

The determination module 111 of the interaction apparatus 11 may be configured to perform, for example, step S1 in FIG. 1. The first display module 112 of the interaction apparatus 11 may be configured to perform, for example, step S2 in FIG. 1. The second display module 113 of the interaction apparatus 11 may be configured to perform, for example, step S3 in FIG. 1. The generation module 114 of the interaction apparatus 11 may be configured to perform, for example, step S4 in FIG. 1.

According to the above interaction apparatus of the present disclosure, after determining the user's intention, different interfaces may be displayed for different user intentions, so that the user may use corresponding functions, thereby improving the user experience.

FIG. 12 is a block diagram of an interaction apparatus according to some other embodiments of the present disclosure.

As shown in FIG. 12, the interaction apparatus 12 includes: a memory 121; and a processor 122 coupled to the memory, where the processor is configured to, based on instructions stored in the memory, execute the interaction method of any one of the above embodiments.

The memory 121 is configured to store one or more computer-readable instructions. The memory 121 may include any combination of various forms of computer-readable storage media, such as a volatile memory and/or a non-volatile memory, including but not limited to a random access memory (RAM), a dynamic random access memory (DRAM), a static random access memory (SRAM), a read-only memory (ROM), and a flash memory. The memory 121 may store, for example, an operating system, an application, a boot loader, a database, and other programs, and may also store various applications, various data, and the like.

The processor 122 is configured to run the computer-readable instructions to implement the interaction method of any one of the above embodiments or the method of any one of the above embodiments. For the specific implementation of each step of the method, reference may be made to the above embodiments, such as the steps in FIG. 1 and FIG. 3, and repeated parts are not described herein again.

By executing the steps of the above interaction method, after determining the user's intention, different interfaces may be displayed for different user intentions, so that the user may use corresponding functions, thereby improving the user experience.

The processor 122 may be embodied as various processing apparatuses, such as a central processing unit (CPU) and a network processor (NP); and may also be a digital signal processor (DSP), an application specific integrated circuit (ASIC), a field programmable gate array (FPGA) or other programmable logic devices, a discrete gate or transistor logic device, or a discrete hardware component. The central processing unit (CPU) may have an X86 or ARM architecture or the like.

The processor 122 and the memory 121 may directly or indirectly communicate with each other. For example, the processor 122 and the memory 121 may communicate through a network. The network may include a wireless network, a wired network, and/or any combination of a wireless network and a wired network. The processor 122 and the memory 121 may also communicate with each other through a system bus, which is not limited in the present disclosure.

It is to be noted that the components of the interaction apparatus 12 shown in FIG. 12 are only exemplary and non-restrictive, and the interaction apparatus 12 may have other components according to actual application needs. The processor 122 may control other components in the interaction apparatus 12 to perform desired functions.

The interaction apparatus 12 may be implemented by software, firmware, and/or hardware, and may be integrated in an apparatus in which a related application is installed.

FIG. 13 is a block diagram of an interaction apparatus according to still some embodiments of the present disclosure.

The interaction apparatus 13 shown in FIG. 13 may be a computer system with a dedicated hardware structure and may perform corresponding functions when a related application is installed.

The interaction apparatus includes, but is not limited to, mobile terminals such as smartphones, notebook computers, personal digital assistants (Personal Digital Assistant, PDA), tablet computers (Tablet Personal Computer, Tablet PC), PMPs (portable multimedia players), in-vehicle terminals (such as car navigation terminals), and wearable devices, and fixed terminals such as digital TVs and desktop computers.

As shown in FIG. 13, a central processing unit (CPU) 131 executes various processes based on a program stored in a read-only memory (ROM) 132 or a program loaded from a storage unit 138 into a random access memory (RAM) 133. The RAM 133 stores data required when the CPU 131 executes various processes as needed. The central processing unit is only exemplary, and it may be other types of processors, such as the various processors described above. The ROM 132, the RAM 133, and the storage unit 138 may be various forms of computer-readable storage media. It is to be noted that while the ROM 132, the RAM 133, and the storage unit 138 are shown separately in FIG. 13, one or more of them may be combined or located in the same or different memories or storage modules.

The CPU 131, the ROM 132, and the RAM 133 are connected to each other via a bus 134. An input/output interface 135 is also connected to the bus 134.

The following components are connected to the input/output interface 135: an input unit 136, such as a touch screen, a touchpad, a keyboard, a mouse, an image sensor, a microphone, an accelerometer, and a gyroscope; an output unit 137, including a display, such as a cathode ray tube (CRT) and a liquid crystal display (LCD), a speaker, a vibrator, and the like; the storage unit 138, including a hard disk, a magnetic tape, and the like; and a communication unit 139, including a network interface card, such as a LAN card and a modem. The communication unit 139 allows communication processing to be performed via a network such as Internet. It is easily understood that although FIG. 13 shows that some components in the interaction apparatus 13 communicate through the bus 134, they may also communicate through a network or other means, where the network may include a wireless network, a wired network, and/or any combination of a wireless network and a wired network.

A driver 1310 is also connected to the input/output interface 135 as needed. A removable medium 1311, such as a magnetic disk, an optical disc, a magneto-optical disc, and a semiconductor memory, is installed in the driver 1310 as needed, so that a computer program read therefrom is installed in the storage unit 138 as needed.

In the case where the above series of processes are implemented by software, a program constituting the software may be installed from a network such as Internet or a storage medium such as the removable medium 1311.

According to an embodiment of the present disclosure, the process described above with reference to the flowchart may be implemented as a computer software program. For example, some embodiments of the present disclosure include a computer program product that, when running on a computer, causes the computer to implement the interaction method of any one of the above embodiments. The computer program product includes computer instructions carried on a computer-readable medium and includes program code for executing the method shown in the flowchart. In such an embodiment, the computer instructions may be downloaded and installed from a network through the communication unit 139, or installed from the storage unit 138, or installed from the ROM 132. When the computer program is executed by the CPU 131, the method of the embodiment of the present disclosure is executed.

By executing the steps of the above interaction method, after determining the user's intention, different interfaces may be displayed for different user intentions, so that the user may use corresponding functions, thereby improving the user experience.

It is to be noted that in the context of the present disclosure, the computer-readable medium may be a tangible medium that may include or store a program for use by or in combination with an instruction execution system, apparatus, or device.

The computer-readable medium may be a computer-readable storage medium, a computer-readable signal medium, or any combination thereof.

The computer-readable storage medium includes, but is not limited to, an electrical, magnetic, optical, electromagnetic, infrared, or semiconductor system, apparatus, or device, or any combination thereof. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium including or storing a program, and the program may be used by or in combination with an instruction execution system, apparatus, or device. The computer-readable storage medium has computer instructions stored thereon, and the instructions, when executed by a processor, implement the interaction method of any one of the above embodiments.

By executing the steps of the above interaction method, after determining the user's intention, different interfaces may be displayed for different user intentions, so that the user may use corresponding functions, thereby improving the user experience.

The computer-readable signal medium may include a data signal propagated on a baseband or as a part of a carrier, and computer-readable program code is carried therein. The data signal propagated in this manner may be in multiple forms and includes, but is not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program for use by or in combination with an instruction execution system, apparatus, or device. The program code contained on the computer-readable medium may be transmitted by any suitable medium, including, but not limited to, a wire, an optical cable, a radio frequency (RF), or any suitable combination thereof.

The above computer-readable medium may be included in the above interaction apparatus or may exist alone without being assembled into the interaction apparatus.

In some embodiments, there is further provided a computer program, including: instructions that, when executed by a processor, cause the processor to execute the method of any one of the above embodiments. For example, the instructions may be embodied as computer program code.

In the embodiments of the present disclosure, the computer program code for performing the operations of the present disclosure may be written in one or more programming languages or a combination thereof, where the programming languages include, but are not limited to, an object-oriented programming language, such as Java, Smalltalk, and C++, and further include conventional procedural programming languages, such as "C" language or similar programming languages. The program code may be executed entirely on a user computer, partly on a user computer, as a stand-alone software package, partly on a user computer and partly on a remote computer, or entirely on a remote computer or server. In the case involving a remote computer, the remote computer may be connected to the user computer through any kind of network (including a local area network (LAN) or a wide area network (WAN)), or may be connected to an external computer (for example, connected by using Internet provided by an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, and the module, program segment, or part of code contains one or more executable instructions for implementing the specified logical functions. It is also to be noted that, in some alternative implementations, functions marked in the blocks may also occur in an order different from that marked in the drawings. For example, two blocks shown in succession may actually be performed substantially in parallel, or they may sometimes be performed in the reverse order, depending on the functions involved. It is also to be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be at least partially performed by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), and the like.

Although some specific embodiments of the present disclosure have been described in detail by way of examples, those skilled in the art should understand that the above examples are only for illustration and not for limiting the scope of the present disclosure. Those skilled in the art should understand that the above embodiments may be modified without departing from the scope and spirit of the present disclosure. The scope of the present disclosure is defined by the appended claims.

What is claimed is:

1. An interaction method, comprising:
determining an interaction intention of a user with an agent;
displaying a first interface in response to the interaction intention comprising a creation intention, wherein the first interface comprises at least one creation instruction template control corresponding to a creation genre;
displaying a second interface in response to the interaction intention not comprising the creation intention, wherein the second interface is a chat interface between the user and the agent; and
generating creation content corresponding to the first creation instruction in response to receiving a first creation instruction input by the user in the first interface or the second interface.

2. The interaction method of claim 1, wherein determining the interaction intention of the user with the agent comprises:
determining the interaction intention based on a history interaction record between the user and the agent.

3. The interaction method of claim 1, further comprising:
entering a third interface in response to a trigger operation of the user on a new document control in the first interface or the second interface, wherein the third interface displays the creation content in a full screen manner to edit the creation content; and
displaying creation content corresponding to at least one of content or a second creation instruction input by the user in the third interface.

4. The interaction method of claim 1, further comprising:
generating an encapsulation entity of the creation content as an interaction record between the user and the agent, and entering a third interface, wherein the third interface displays the creation content in a full screen manner to edit the creation content.

5. The interaction method of claim 1, further comprising:
displaying an encapsulation entity of the creation content in a chat interface between the user and the agent; and
entering a third interface in response to a trigger operation of the user on a package, wherein the third interface displays the creation content in a full screen manner to edit the creation content.

6. The interaction method of claim 3, further comprising:
displaying prompt information in the third interface in a form of a floating layer in response to completion of editing the creation content, wherein the prompt information comprises at least one of a progress prompt indicating completion of the editing or a recommended editing instruction for subsequent editing.

7. The interaction method of claim 6, wherein displaying the prompt information comprises:
displaying the prompt information within a specified time after the completion of editing the creation content.

8. The interaction method of claim 6, further comprising:
displaying a history interaction record related to the first creation instruction in the third interface in the form of a floating layer in response to a trigger operation of the user on the prompt information, wherein the history interaction record comprises an encapsulation entity of edited creation content.

9. The interaction method of claim 3, further comprising:
displaying an input box for chatting with the agent in the third interface in a form of a floating layer; and
editing the creation content based on a first editing instruction input by the user in the input box.

10. The interaction method of claim 3, further comprising:
recommending at least one candidate editing instruction related to the creation content to the user, in the third interface, in response to a trigger operation of the user on the creation content; and
editing the creation content based on a second editing instruction selected by the user from the candidate editing instruction(s).

11. The interaction method of claim 3, further comprising:
in the third interface, recommending at least one candidate editing instruction related to the target content to the user in response to a trigger operation of the user on target content in the creation content, and editing the target content based on a third editing instruction selected by the user from the candidate editing instruction(s); or
in the third interface, editing the target content based on a fourth editing instruction input by the user in an input box in the third interface in response to a trigger operation of the user on target content in the creation content.

12. The interaction method of claim 3, further comprising:
sharing the creation content in response to a trigger operation of the user on a sharing control in the third interface.

13. An interaction apparatus, comprising:
at least one memory; and
at least one processor coupled to the at least one memory, wherein the at least one processor is configured to, based on instructions stored in the at least one memory, execute an interaction method , comprising:
determining an interaction intention of a user with an agent;
displaying a first interface in response to the interaction intention comprising a creation intention, wherein the first interface comprises at least one creation instruction template control corresponding to a creation genre;
displaying a second interface in response to the interaction intention not comprising the creation intention, wherein the second interface is a chat interface between the user and the agent; and
generating creation content corresponding to the first creation instruction in response to receiving a first creation instruction input by the user in the first interface or the second interface.

14. The interaction apparatus of claim 13, wherein determining the interaction intention of the user with the agent comprises:
determining the interaction intention based on a history interaction record between the user and the agent.

15. The interaction apparatus of claim 13, wherein the interaction method further comprising:
entering a third interface in response to a trigger operation of the user on a new document control in the first interface or the second interface, wherein the third interface displays the creation content in a full screen manner to edit the creation content; and
displaying creation content corresponding to at least one of content or a second creation instruction input by the user in the third interface.

16. The interaction apparatus of claim 13, wherein the interaction method further comprising:
generating an encapsulation entity of the creation content as an interaction record between the user and the agent, and entering a third interface, wherein the third interface displays the creation content in a full screen manner to edit the creation content.

17. A non-transitory computer-readable storage medium having computer instructions stored thereon, wherein the instructions, when executed by a processor, implement an interaction method, comprising:
determining an interaction intention of a user with an agent;
displaying a first interface in response to the interaction intention comprising a creation intention, wherein the first interface comprises at least one creation instruction template control corresponding to a creation genre;
displaying a second interface in response to the interaction intention not comprising the creation intention, wherein the second interface is a chat interface between the user and the agent; and
generating creation content corresponding to the first creation instruction in response to receiving a first creation instruction input by the user in the first interface or the second interface.

18. The non-transitory computer-readable storage medium of claim 17, wherein determining the interaction intention of the user with the agent comprises:
determining the interaction intention based on a history interaction record between the user and the agent.

19. The non-transitory computer-readable storage medium of claim 17, wherein the interaction method further comprising:
entering a third interface in response to a trigger operation of the user on a new document control in the first interface or the second interface, wherein the third interface displays the creation content in a full screen manner to edit the creation content; and
displaying creation content corresponding to at least one of content or a second creation instruction input by the user in the third interface.

20. The non-transitory computer-readable storage medium of claim 17, wherein the interaction method further comprising:
generating an encapsulation entity of the creation content as an interaction record between the user and the agent, and entering a third interface, wherein the third interface displays the creation content in a full screen manner to edit the creation content.
